(19) United States
(12) Patent Application Publication
(10) Pub. No.: US 2006/0210738 A1
(43) Pub. Date: Sep. 21, 2006

(54) Stock material, inflatable cushioning product, and method

(76) Inventors: Jean-Marc Slovencik, Uhrwiller (FR); Paul Deis, Hagenau (FR)

Correspondence Address: WOOD, HERRON & EVANS, LLP, 2700 CAREW TOWER, 441 VINE STREET, CINCINNATI, OH, 45202, US

(21) Appl. No.: 11/101,103

(22) Filed: Apr. 7, 2005

Related U.S. Application Data
(63) Continuation-in-part of application No. 29/225,860, filed on Mar. 21, 2005.

(51) Int. Cl. B65B 31/00; B32B 27/32

(52) U.S. Cl. 428/35.2; 53/403; 428/196; 428/195.1

(57) ABSTRACT

An inflatable cushioning product comprises an elongated plastic film tube, the tube having a longitudinal series of transversely oriented seal lines, the seal lines defining, when the tube is inflated, an interconnected string of inflated plastic pillows, the tube having a longitudinal series of transversely oriented rows of quilting seals and a lateral series of longitudinally oriented columns of quilting seals which produce a quilted effect, each quilting seal having a seal edge which defines an uninflated portion of the tube within a perimeter of the edge.

### RELATED APPLICATIONS

This application is a continuation-in-part of application Ser. No. 29/225,860 filed Mar. 21, 2005 hereby incorporated by reference herein.

### FIELD OF THE INVENTION

This invention relates generally to protective packaging products, and more specifically to an improved inflatable cushioning product for use in wrapping items for protection during shipment.

### BACKGROUND OF THE INVENTION

In the process of shipping an item from one location to another, a protective packaging product is typically placed in the shipping carton or box, to fill any voids and/or to cushion the item during the shipping process. Examples of protective packaging products are foam “peanuts,” air filled plastic “pillows,” and paper sheet “converted” into crumpled paper pads or “dunnage.”

It is desirable to provide an improved air filled plastic pillow having improved wrapping characteristics which enable a string of such pillows to be more effectively wrapped around the item to be shipped and thereby improving the cushioning of the item.

### SUMMARY OF THE INVENTION

The present invention is an inflatable cushioning product comprising an elongated plastic film tube, the tube having a longitudinal series of transversely oriented seal lines, the seal lines defining, when the tube is inflated, an interconnected string of inflated plastic pillows, the tube having a longitudinal series of transversely oriented rows of quilting seals and a lateral series of longitudinally oriented columns of quilting seals which produce a quilted effect, each quilting seal having a seal edge which defines an uninflated portion of the tube within a perimeter of the edge.

The inflatable cushioning product can further include a longitudinal series of transversely oriented perforation lines. Adjacent columns of the quilting seals can be shifted longitudinally relative to one another to thereby produce a staggered pattern. Adjacent rows of the quilting seals can be shifted laterally relative to one another to thereby produce a staggered pattern. The quilting seals can be circular. The circular quilting seals can be about 1 inch in diameter. Each circular quilting seal can be a ring. Each circular quilting seal ring can have a diameter of about 1 inch and a width of about one-eighth inch. Each circular quilting seal can be a pair of concentric rings. One of the concentric rings can have a diameter of about 1 inch and a width of about one-eighth inch, and the other of the concentric rings can have a diameter of about one-half inch and a width of about one-eighth inch. The tube can be about 8 inches wide.

In another aspect, the present invention is a method of forming an inflatable cushioning product comprising providing an elongated plastic film tube with a longitudinal series of transversely oriented seal lines, the seal lines defining, when the tube is inflated, an interconnected string of inflated plastic pillows, and with a longitudinal series of transversely oriented rows of quilting seals and a lateral series of longitudinally oriented columns of quilting seals, each quilting seal having a seal edge which defines an uninflated portion of the tube within a perimeter of the edge, forming an opening in the tube, inflating the tube through the opening, and sealing the opening.

The step of providing the tube with the longitudinal series of transversely oriented seal lines, the longitudinal series of transversely oriented rows of quilting seals, and the lateral series of longitudinally oriented columns of quilting seals can occur prior to the steps of forming the opening in the tube, inflating the tube through the opening, and sealing the opening. The step of providing the tube with the longitudinal series of transversely oriented seal lines, the longitudinal series of transversely oriented rows of quilting seals, and the lateral series of longitudinally oriented columns of quilting seals can occur prior to feeding the tube into a machine which performs the steps of forming the opening in the tube, inflating the tube through the opening, and sealing the opening.

These and other features and advantages of the present invention will become more readily apparent during the following detailed description taken in conjunction with the drawings herein, in which:

### BRIEF DESCRIPTION OF THE DRAWINGS

FIG. 1 is a perspective view of a machine for producing the inflatable cushioning product of the present invention,

FIG. 2 is a top view thereof,

FIG. 3 is a perspective view of the inflatable cushioning product made on the machine of FIGS. 1 and 2,

FIG. 4 is cross-sectional view taken along line 4-4 in FIG. 3,

FIG. 5 is a top view of another embodiment of inflatable cushioning product made on the machine of FIGS. 1 and 2,

FIG. 6 is a cross-sectional view taken along line 6-6 in FIG. 5, and

FIG. 7 is a top view of yet another embodiment of inflatable cushioning product made on the machine of FIGS. 1 and 2.

### DETAILED DESCRIPTION OF THE INVENTION

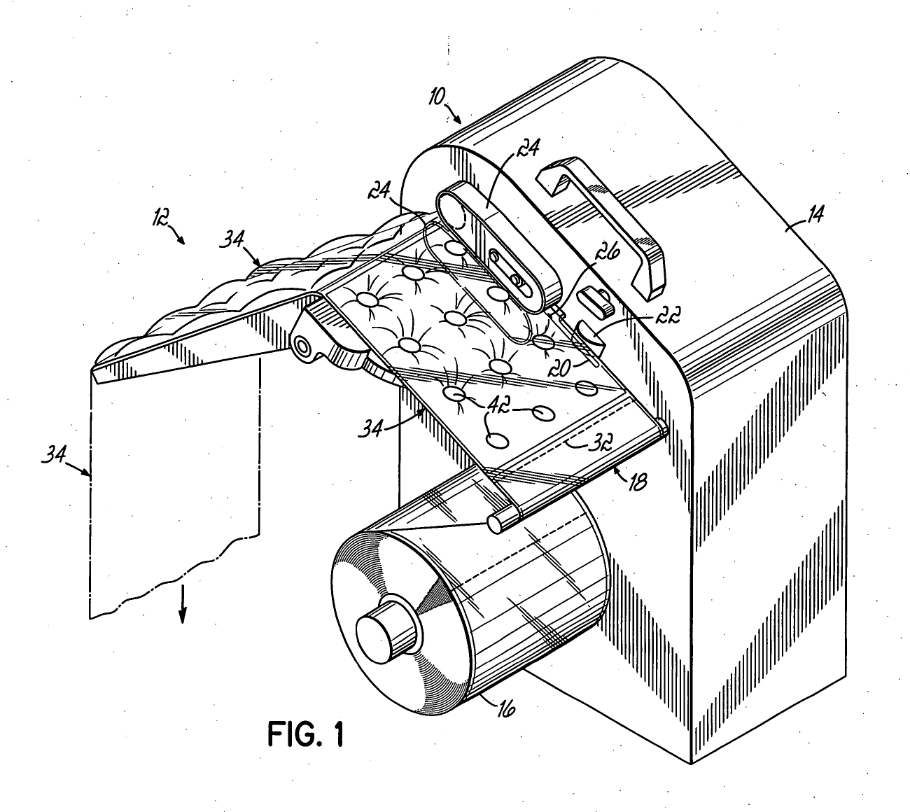

Referring first to FIG. 1, there is illustrated a machine 10 for producing the inflatable cushioning product 12 of the present invention. Machine 10 can be, for example, an Airplus® Excel machine commercially available from the Assignee of the present invention.

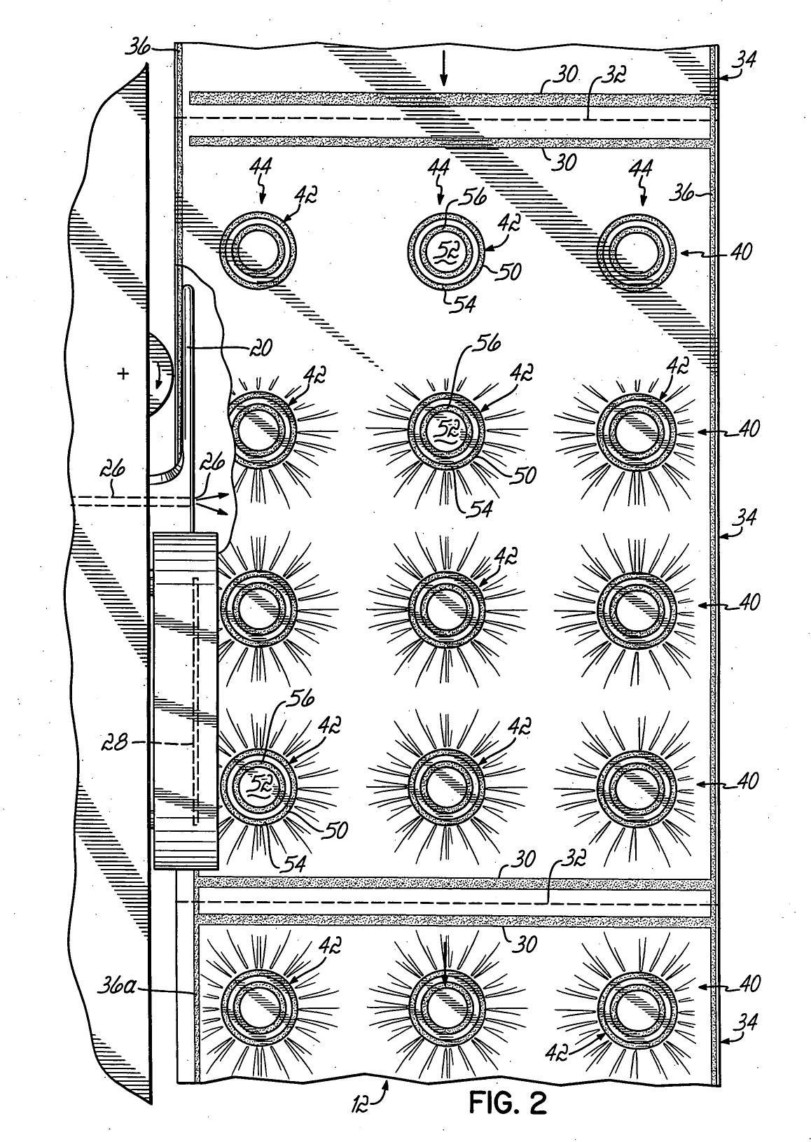

Referring now to FIGS. 1 and 2, machine 10 can include a machine frame 14, a stock supply roll 16 which supplies the machine 10 with a plastic (for example low density polyethylene) film tube 18, a tube slitter 20, a roller 22, a pair of drive belts 24, 24, an inflation nozzle 26, and an edge sealer 28. The tube slitter 20 is for slitting an edge of the tube 18 open so that the tube 18 can be inflated. The roller 22 is for maintaining the tube 18 in contact with the slitter 20. The pair of drive belts 24, 24 are for drawing the tube 18 from the supply roll 16 and advancing the tube 18 through the machine 10. The inflation nozzle 26, which can be connected to a source of compressed air (not shown), is for inflating the slit-open tube 18. The edge sealer 28 is for sealing, e.g. heat sealing, the slit-open edge of the tube 18 after inflation.

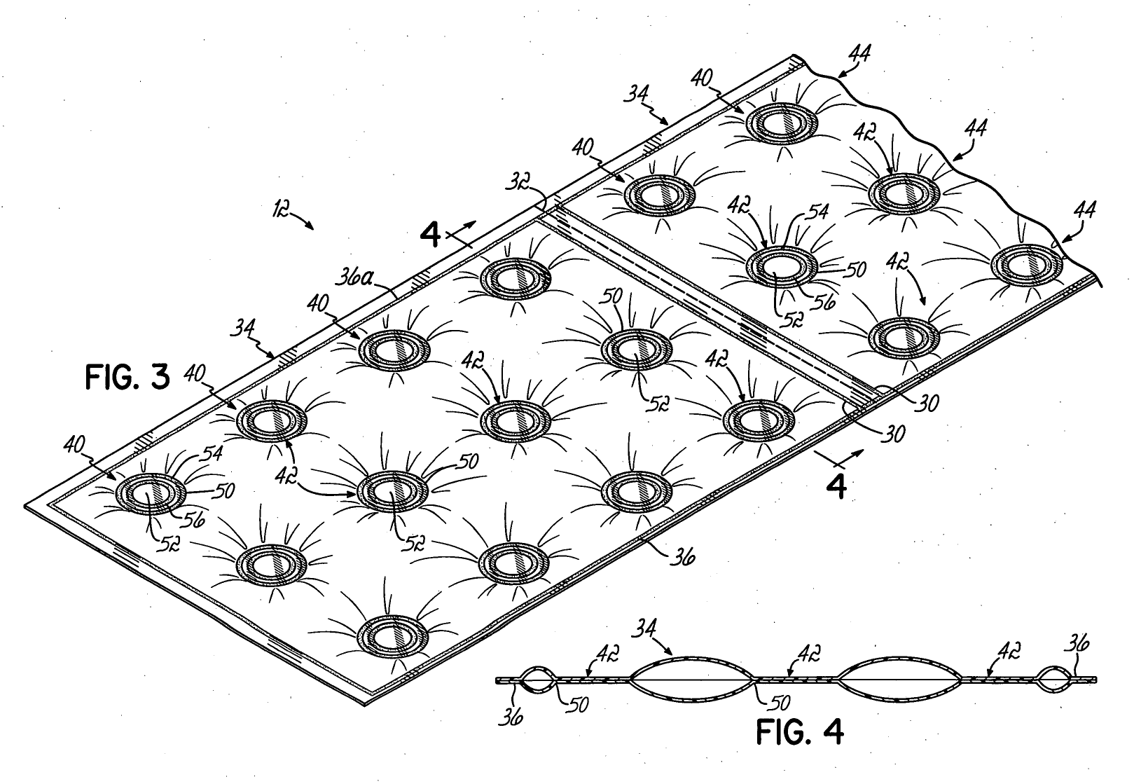

Referring to FIG. 2, it will be seen that tube 18 can have a longitudinal series of transversely oriented seal lines 30 and a longitudinal series of transversely oriented perforation lines 32. Seal lines 30 can be, e.g. heat seal lines. The seal lines 30 and perforation lines 32 form, when tube 18 is inflated into the cushioning product 12, an interconnected string of separable inflated plastic pillows 34 (FIG. 3). As illustrated, tube 18 can be formed of two elongated sheets of plastic film which have their lateral edges sealed together at seal lines 36, 36, e.g. heat seal lines 36, 36. Alternatively, tube 18 could be formed by sealing the lateral edges of a single elongated sheet of plastic film together (not shown). The inflated pillows 34 have a new seal line 36a formed by edge sealer 28 to re-seal the slit-open edge of the tube 18.

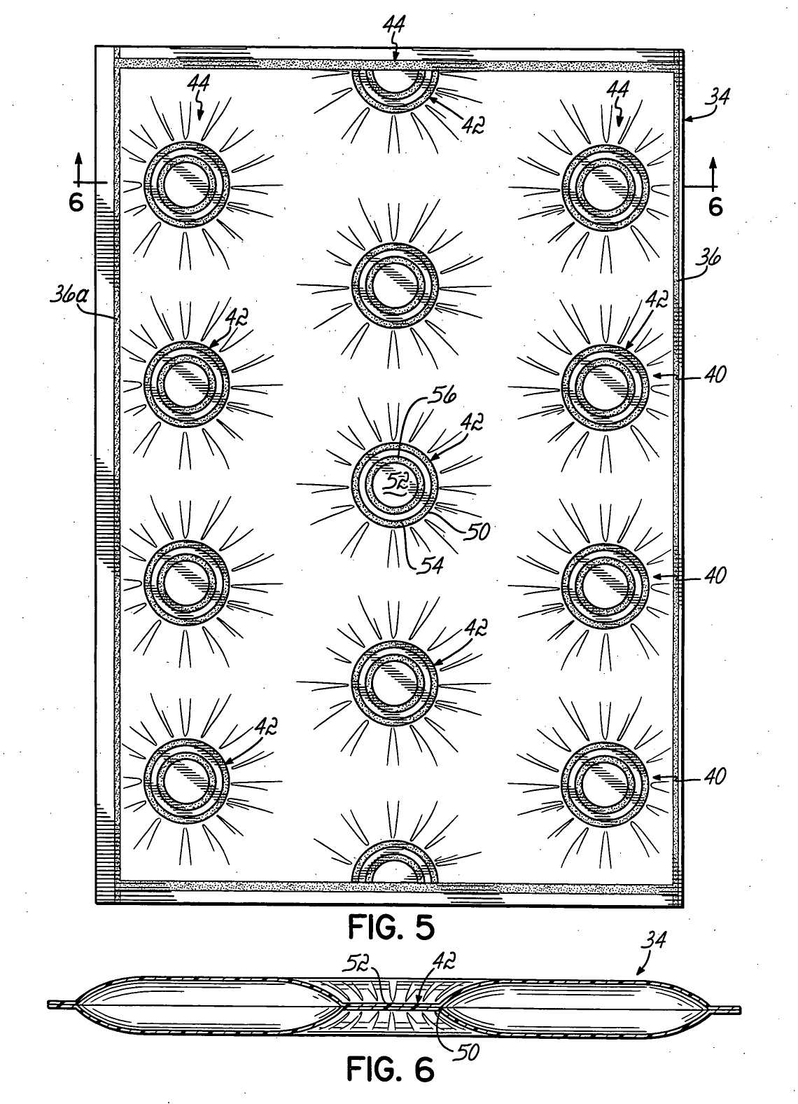

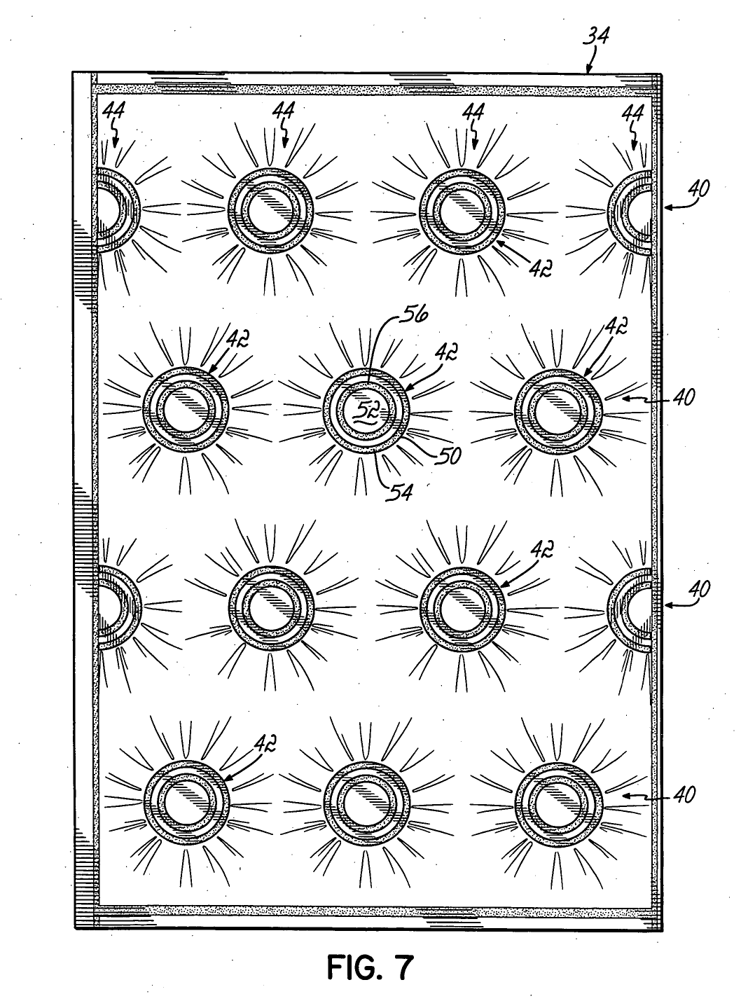

Referring to FIGS. 2-4, tube 18 (and resulting pillows 34) have a longitudinal series of transversely oriented rows 40 of quilting seals 42, and a lateral series of longitudinally oriented columns 44 of quilting seals 42. Alternatively, and as shown in FIG. 5, the pattern of quilting seals 42 on tube 18 can be such that one or more columns 44 of quilting seals 42 can be shifted longitudinally one way or the other to produce a staggered effect or pattern. Alternatively, and as shown in FIG. 7, the pattern of quilting seals 42 on tube 18 can be such that one or more rows 40 of quilting seals 42 can be shifted laterally one way or the other to produce a staggered effect or pattern.

Referring now to FIGS. 3 and 4, quilting seals 42 each have a seal edge 50 which defines an uninflated portion 52 of the tube 18 (and pillows 34) within a perimeter of the edge 50. The quilting seals 42 can be circular. Other shapes of quilting seals 42 can be utilized, for example, square, rectangular, triangular, oval, pentagonal, hexagonal, octagonal, star-shaped, etc. The circular quilting seals can be about 1 inch in diameter. Each circular quilting seal 42 can be a ring 54. Each ring 54 can have a diameter of about 1 inch and a width of about one-eighth inch. Each circular quilting seal 42 can be a pair 54, 56 of concentric rings. Ring 56 can have a diameter of about one-half inch and a width of about one-eighth inch. Tube 18 can be about 8 inches wide.

1. An inflatable cushioning product comprising:
an elongated plastic film tube,
said tube having a longitudinal series of transversely oriented seal lines,
said seal lines defining, when said tube is inflated, an interconnected string of inflated plastic pillows,
said tube having a longitudinal series of transversely oriented rows of quilting seals and a lateral series of longitudinally oriented columns of quilting seals which produce a quilted effect,
each said quilting seal having a seal edge which defines an uninflated portion of said tube within a perimeter of the edge.

2. The inflatable cushioning product of claim 1 further including a longitudinal series of transversely oriented perforation lines.

3. The inflatable cushioning product of claim 1 wherein adjacent columns of said quilting seals are shifted longitudinally relative to one another to thereby produce a staggered pattern.

4. The inflatable cushioning product of claim 1 wherein adjacent rows of said quilting seals are shifted laterally relative to one another to thereby produce a staggered pattern.

5. The inflatable cushioning product of claim 1 wherein said quilting seals are circular.

6. The inflatable cushioning product of claim 5 wherein said circular quilting seals are about 1 inch in diameter.

7. The inflatable cushioning product of claim 5 wherein each said circular quilting seal is a ring.

8. The inflatable cushioning product of claim 5 wherein each said circular quilting seal is a ring having a diameter of about 1 inch and a width of about one-eighth inch.

9. The inflatable cushioning product of claim 5 wherein each said circular quilting seal is a pair of concentric rings.

10. The inflatable cushioning product of claim 5 wherein each said circular quilting seal is a pair of concentric rings, one of said concentric rings having a diameter of about 1 inch and a width of about one-eighth inch, the other of said concentric rings having a diameter of about one-half inch and a width of about one-eighth inch.

11. The inflatable cushioning product of claim 10 wherein said tube is about 8 inches wide.

12. A method of forming an inflatable cushioning product comprising:
providing an elongated plastic film tube with a longitudinal series of transversely oriented seal lines, the seal lines defining, when the tube is inflated, an interconnected string of inflated plastic pillows, and with a longitudinal series of transversely oriented rows of quilting seals and a lateral series of longitudinally oriented columns of quilting seals, each quilting seal having a seal edge which defines an uninflated portion of the tube within a perimeter of the edge,
forming an opening in the tube,
inflating the tube through the opening, and
sealing the opening.

13. The method of claim 12 wherein the step of providing an elongated plastic film tube comprises providing an elongated plastic film tube with a longitudinal series of transversely oriented seal lines and with a longitudinal series of transversely oriented perforation lines.

14. The method of claim 12 wherein adjacent columns of the quilting seals are shifted longitudinally relative to one another to thereby produce a staggered pattern.

15. The method of claim 12 wherein adjacent rows of the quilting seals are shifted laterally relative to one another to thereby produce a staggered pattern.

16. The method of claim 12 wherein the quilting seals are circular.

17. The method of claim 16 wherein the circular quilting seals are about 1 inch in diameter.

18. The method of claim 16 wherein each circular quilting seal is a ring.

19. The method of claim 16 wherein each circular quilting seal is a ring having a diameter of about 1 inch and a width of about one-eighth inch.

20. The method of claim 16 wherein each circular quilting seal is a pair of concentric rings.

21. The method of claim 16 wherein each circular quilting seal is a pair of concentric rings, one of the concentric rings having a diameter of about 1 inch and a width of about one-eighth inch, the other of the concentric rings having a diameter of about one-half inch and a width of about one-eighth inch.

22. The method of claim 21 wherein the tube is about 8 inches wide.

23. The method of claim 12 wherein the step of providing the tube with the longitudinal series of transversely oriented seal lines, the longitudinal series of transversely oriented rows of quilting seals, and the lateral series of longitudinally oriented columns of quilting seals occurs prior to the steps of forming the opening in the tube, inflating the tube through the opening, and sealing the opening.

24. The method of claim 12 wherein the step of providing the tube with the longitudinal series of transversely oriented seal lines, the longitudinal series of transversely oriented rows of quilting seals, and the lateral series of longitudinally oriented columns of quilting seals occurs prior to feeding the tube into a machine which performs the steps of forming the opening in the tube, inflating the tube through the opening, and sealing the opening.
